(19) United States
(12) Patent Application Publication
(10) Pub. No.: US 2005/0271047 A1
(43) Pub. Date: Dec. 8, 2005

(54) Method and system for managing multiple overlapping address domains

(76) Inventors: Russell J. Huonder, Fort Collins, CO (US); Srikanth Natarajan, Fort Collins, CO (US); Dipankar Gupta, Fort Collins, CO (US); Daniel Okine, Fort Collins, CO (US); Anthony P. Walker, Fort Collins, CO (US); Nitya Ganesan, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/858,891

(22) Filed: Jun. 2, 2004

(51) Int. Cl. H04L 12/56

(52) U.S. Cl. 370/389

(57) ABSTRACT

One embodiment disclosed relates to a method of configuring a network including multiple overlapping private address domains. A configuration file is created for each overlapping address domain (OAD). The configuration file includes an identifier for the OAD, a gateway address to the OAD, and mappings between private addresses in the OAD and corresponding management addresses. Another embodiment relates to a system for managing a network including multiple OADs. Another embodiment relates to a method of processing a trap from a network with multiple OADs. Another embodiment relates to a method of finding an active route across a static NAT device.

### BACKGROUND OF THE INVENTION

1. Field of the Invention

The present invention relates generally to computer networks and network management.

2. Description of the Background Art

Private address domains are commonly used in local area networks (LANs). Reasons for using private address domains include, among others, hiding internal addresses, the freedom of such an internal addressing scheme, and insulating the internal addresses from enterprise or service provider address changes. Such private address domains are typically implemented using a network address translation (NAT) device to route packets between address realms.

For explanatory purposes, the operation of a conventional NAT device is now described in relation to FIGS. 1A and 1B. A conventional NAT device attempts to provide a transparent routing solution to end hosts trying to communicate from disparate address realms. This is achieved by modifying end node addresses en-route and maintaining state for these updates so that datagrams pertaining to a session are routed to the right end-node in either realm.

FIG. 1A shows a private network 102 coupled via a NAT device 104 to an external network 106. The private network 102 may comprise a local area network including various interconnected hosts. One example host 108 may have a private internet protocol (IP) address of, for instance, 10.1.1.5.

In this scenario, the host 108 generates and transmits a transmission control protocol (TCP) packet 110 requesting a connection, in this instance, to the domain name “openview.hp.com”. Of course, this resource is just a particular example, and the connection may be to another resource. The packet 110 includes a header 112 and content (or payload) 114. The header 112 includes, among various other data, the source IP address of the host 108. In this example, the source address is 10.1.1.5. The packet content 114 may include, for example, a hypertext transfer protocol (http) request to connect to and receive a web page from the example domain “openview.hp.com”. Of course, the request may be for other web pages, and may utilize other protocols besides the http protocol (for example, file transfer protocol, and so on).

The packet 110 is communicated to and received by the NAT device 104. The NAT device 104 translates the source address from the internal IP address (in this instance, 10.1.1.5) in the original header 112 to a corresponding external IP address (in this instance, 15.133.219.25). The internal address is typically private and non-unique, while the external address is typically public and unique. In addition, the NAT device 104 recalculates and replaces the checksum for the packet. The modified packet 116, including the modified header 118 with translated source, is transmitted from the NAT device 104 to the external network 106 so as to reach its destination.

As depicted in FIG. 1B, in response to receiving the packet 110, a server for the domain “openview.hp.com” returns a responsive packet 152. The responsive packet 152 includes a header 154 and content (or payload) 156. Here the content 156 may include, for example, responsive information in the form of hypertext markup language (html). The header 154 includes, among various other data, the destination IP address of the host 108. Here, the destination address is the external IP address (in this instance, 15.133.219.25) retrieved by the server from the source field of the request packet 116.

The packet 152 is communicated to and received by the NAT device 104. The NAT device 104 translates the destination address from the external IP address (in this instance, 15.133.219.25) in the external header 154 to the corresponding internal IP address (in this instance, 10.1.1.5). In addition, the NAT device 104 recalculates and replaces the checksum for the packet. The modified packet 158, including the modified header 160 with translated destination, is transmitted from the NAT device 104 to the private network 102 so as to reach the destination host 108.

It is desirable to manage network components or devices by way of a central management system. For example, the Simple Network Management Protocol (SNMP) and Common Management Information Protocol (CMIP) are network management protocols providing mechanisms to communicate management information between network components on the network. Using such protocols, network components can be monitored and controlled from a management system, such as one residing on a UNIX server. Network components may include networked personal computers, workstations, servers, routers, and bridges.

One mechanism by which various network devices communicate with a management system is via SNMP traps or CMIP events. Hereafter, “events” will be used to refer to either SNMP traps or CMIP events. Events allow for unsolicited notifications to be sent from one network device to another. This same mechanism can be used for communication between various cooperating software components within the management system.

There are several software products that receive events and allow a user to manage network devices. One of these products, Network Node Manager (NNM) from the Hewlett-Packard Company of Palo Alto, Calif., enables a user to manage network devices using a graphical user interface (GUI) along with graphically representing relationships between network devices. Hereafter “NNM” may be used to generically refer to a product that receives events and allows a user to manage network devices, such as Network Node Manager.

### SUMMARY

One embodiment of the invention relates to a method of configuring a network including multiple overlapping private address domains. A configuration file is created for each overlapping address domain (OAD). The configuration file includes an identifier for the OAD, a gateway address to the OAD, and mappings between private addresses in the OAD and corresponding management addresses.

Another embodiment relates to a system for managing a network including multiple OADs. The system has a computer system including software for a network management system and a plurality of network address translation (NAT) devices. Each NAT device in the plurality is communicatively coupled to said computer system and communicatively coupled to one of the OADs. A route distinguisher is associated with each OAD to facilitate management thereof.

Another embodiment relates to a method of processing a trap from a network with multiple OADs. A trap packet originating from a managed network device is received, and a management internet protocol (IP) address is extracted from its header. A domain identifier and a private IP address corresponding to the management IP address is determined and used to uniquely identify the managed network device.

Another embodiment relates to a method of finding an active route across a static NAT device. A gateway to a private network is found, wherein the gateway comprises the static NAT device. A private address of a next device in the private network is looked-up, and a corresponding management address is determined. The management address is added to a route being calculated. The looking-up, determining, and adding steps are repeated until the next device comprises a destination device.

### BRIEF DESCRIPTION OF THE DRAWINGS

FIGS. 1A and 1B are illustrations depicting the operation of a network address translation device.

FIG. 2 depicts a network with multiple overlapping private address domains.

FIG. 3 depicts the use of route distinguishers to facilitate the central management of multiple overlapping address domains in accordance with an embodiment of the invention.

FIG. 4 is a flow chart of a configuration process for a central system managing multiple overlapping address domains in accordance with an embodiment of the invention.

FIG. 5 is a screen shot depicting a graphical user interface relating to extended topology configuration in accordance with an embodiment of the invention.

FIG. 6 is a schematic diagram of the architecture for a central system managing multiple overlapping address domains in accordance with an embodiment of the invention.

FIG. 7 is a flow chart depicting a method of processing a network management trap by a network management system in accordance with an embodiment of the invention.

FIGS. 8A and 8B are flow diagrams depicting an algorithm for finding an active route taken by a packet crossing a static NAT device into a private network in accordance with an embodiment of the invention.

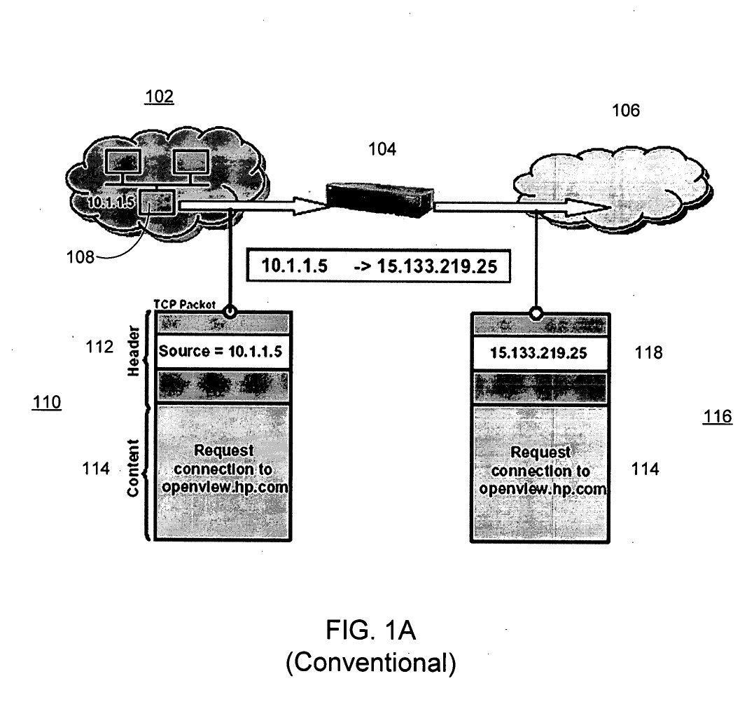

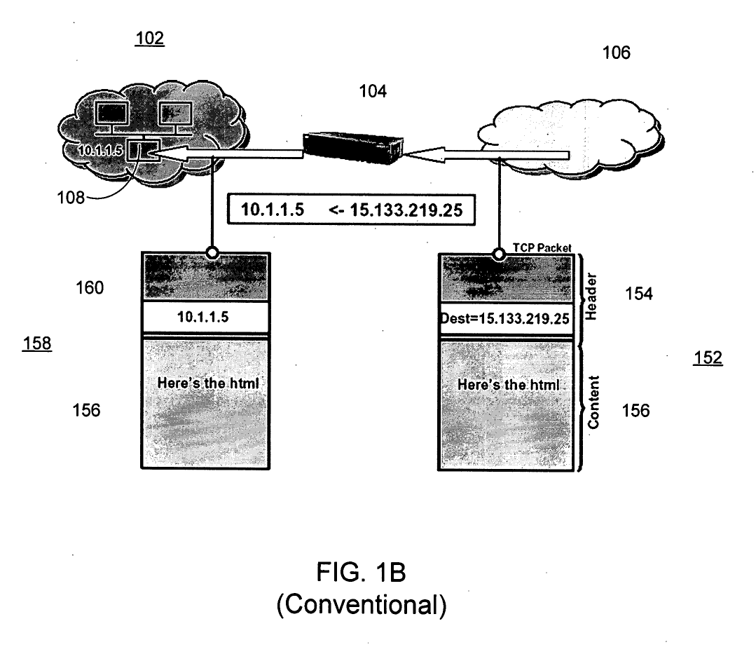

### DETAILED DESCRIPTION

The present invention relates to the management of multiple private networks with overlapping address domains (OADs). Such networks are commonly found in service provider environments. Each customer may have one or more private networks interconnected to the service provider network.

It is common for one private network to have overlapping internet protocol (IP) addresses with another private network. Unfortunately, such overlapping address domains make it more complicated and challenging to provide centralized network management over these private networks.

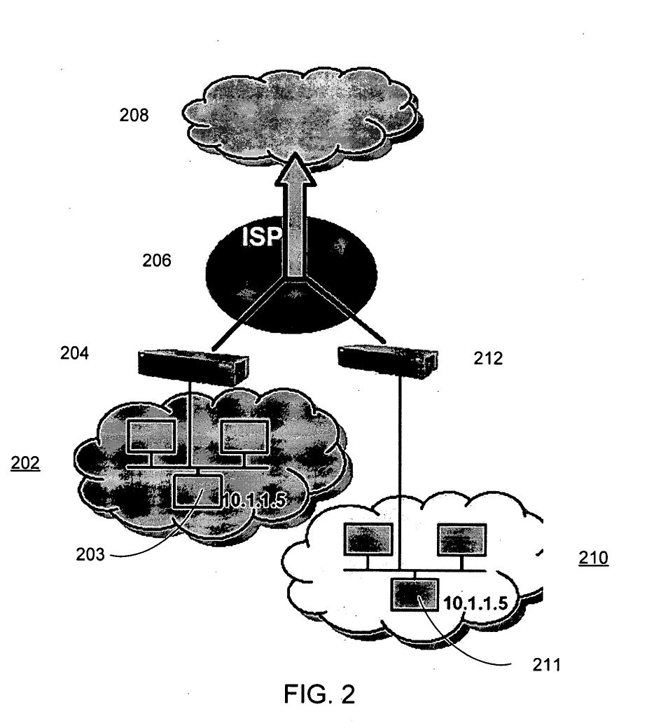

An example network with multiple overlapping private address domains is described in relation to FIG. 2. In this example, an Internet Service Provider (ISP) 206 provides connectivity to the public Internet 208 to various private networks. Two such networks are depicted in FIG. 2, but the ISP 206 may connect to any number of private networks. In this example, the two private networks 202 and 210 are communicatively coupled to the ISP system 206 by way of NAT devices 204 and 212, respectively. In addition, these two private networks 202 and 210 include overlapping private address domains. Two address domains are overlapping when they have at least one host IP address in common. As depicted, one host 203 in the first private network 202 has the same private IP address (in this example, 10.1.1.5) as another host 211 in the second private network 210.

There are difficulties in providing centralized management of private networks with overlapping address domains. One reason for these difficulties is that network address translation may not work well when the applications use IP addresses as part of the protocol itself. For example, an SNMP query to a device would return private addresses in the payload of the response. Hence, it can be problematic to identify the correct source device and to navigate easily to views of the specific domain from a single centralized management system. As described below, a solution to these difficulties is provided by embodiments of the present invention.

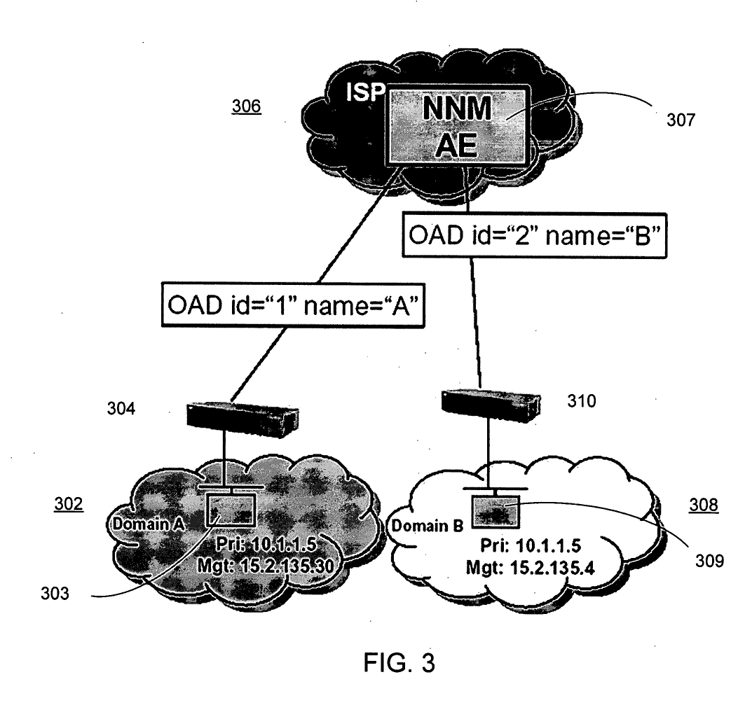

FIG. 3 depicts the use of route distinguishers to facilitate the central management of multiple overlapping address domains in accordance with an embodiment of the invention. In this example, the ISP network 306 provides connectivity to the public Internet (not shown) to various private networks. Again, two such networks are depicted in FIG. 3, but the ISP network 306 may connect to any number of private networks. In this example, the two private networks 302 and 308 are communicatively coupled to the ISP system 306 by way of NAT devices 304 and 310, respectively. In addition, these two private networks 302 and 308 include overlapping private address domains. As depicted, one host 303 in the first private network 302 has the same private IP address (in this example, 10.1.1.5) as another host 309 in the second private network 308.

As shown in FIG. 3, the ISP network 306 may include a centralized management system 307 that is advantageously configured to manage network components in multiple overlapping private address domains. In one specific instance, the centralized management system 307 may comprise an advanced edition of the Network Node Manager (NNM AE) from the Hewlett Packard Company. Of course, embodiments of the invention may also be implemented in other network management systems.

In accordance with an embodiment of the invention, route distinguishers are advantageously utilized to manage the private networks with overlapping address domains. In one embodiment, a route distinguisher may comprise an identifier number (“OAD id”) and a descriptive string (“name”) for each overlapping address domain. In one specific implementation, the OAD id may comprise a 32-bit integer greater than zero. By definition, each overlapping address domain comprises a set of IPv4 addresses that are internally non-overlapping (i.e. none of the addresses in the set are duplicates) and typically are directly routable from each other without manipulation of the IPv4 header. For example, an OAD might represent the set of private IP addresses of a small business or of a specific workgroup in a larger company. In the simple example shown in FIG. 3, the first overlapping domain (Domain A) is assigned OAD id=1 and name=“A”, and the second overlapping domain (Domain B) is assigned OAD id=2 and name=“B”.

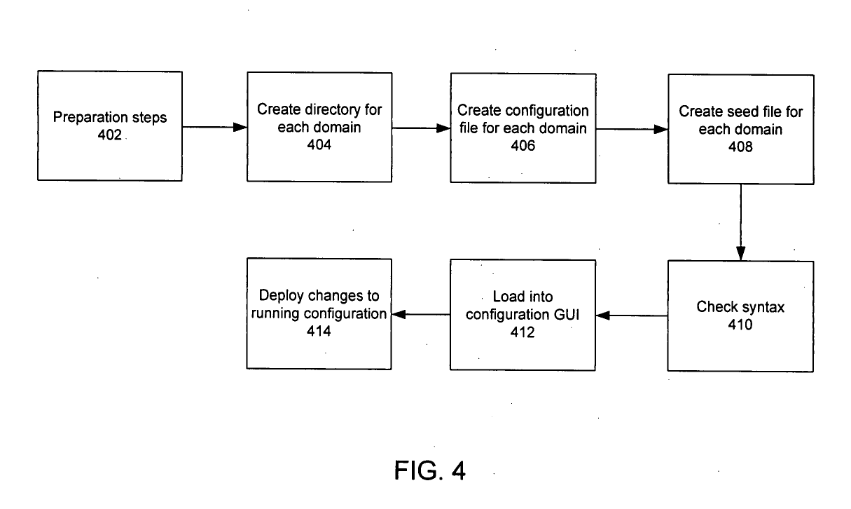

FIG. 4 is a flow chart of a configuration process for a central system managing multiple overlapping address domains in accordance with an embodiment of the invention. First, a few steps may be done or confirmed in preparation. These preparation steps 402 include setting up the NAT devices for the overlapping private address domains with static NAT tables. The static NAT tables provide unique IP addresses that can be used to communicate to the hosts having the overlapping private addresses. In addition, the domain name server (DNS) may be set up so as to be based on routable (internal) addresses, and the SNMP configuration is set up so as to be based on management (external) addresses.

As shown in FIG. 4, the process continues with several other steps. The next steps include creating 404 a directory for each domain, creating 406 a configuration file for each domain, and creating 408 a seed file for each domain. These steps are shown in one particular order, but they may be done in parallel or in a different order.

The directory created 404 is a separate directory defined for each OAD. The directory is created 404 so as to be accessible by the centralized network management system at the ISP. For example, in a specific implementation under a UNIX-type operating system, the directory created may be, for instance, beneath the directory named “$OV_CONF/nnmet/dupip”. If there is two OADs (for example, for a “red” group and a “blue” group), then two directories are created, one may be named “$OV_CONF/nnmet/dupip/red” and the other may be named “$OV_CONF/nnmet/dupip/blue”.

The configuration file is created 406 within each such new directory. In one implementation, the configuration file may be named “dupip.conf”. Commands are included in the configuration file. These commands define the associated OAD.

One command may define the OAD. For example, this command may be of the form: OverlappingAddressDomain id=“number” name=“string”. Gateway, routable, and mapping commands which follow this are for this address domain. One and only one OverlappingAddressDomain command is needed per configuration file.

Another command (“gateway”) may be used to specify gateways to be managed for this particular OAD. Multiple such commands may follow the OAD definition command. Each such command gives a gateway IP address for the OAD. In one embodiment, the address given is a management IP address. A management address is the address that is used by the management server to communicate with the network device. This address should be unique across all IPv4 addresses visible to the instance of the management station. For example, this command may be of the form: Gateway IP=“IP addr”.

Another command (“routable”) may be used to specify a management IP address which is routable. Multiple such commands may follow the OAD definition command. In one implementation, wildcards may be allowed in these mappings. For example, this command may be of the form: Routable managementIP=“IP addr”.

Another command (“mapping”) may be used to delineate a mapping between private addresses and management addresses. Multiple such commands may follow the OAD definition command. For example, this command may be of the form: Mapping privateIP=“IP addr” managementIP=“IP addr”.

In addition to the configuration file, a seed file is also created 408 in the directory for each OAD. The seed file defines the discovery zone for the OAD. In other words, only the IP addresses in the seed file are discovered. Each seed file includes a list of the management IP addresses to be managed for a given OAD. In one implementation, one management IP address is entered per line, along with an optional hostname (which should be resolvable to the management address at the management station).

Once the configuration and seed files have been created, a command may be run to check 410 the syntax of these files. In one implementation, this command may be called the “ovdupip -u” command. This command may also be run after any modification of the configuration or seed files so as to make sure the files remain syntactically correct. If there are errors in the files, this checking tool may return an indication of what is wrong and where to look to remedy the problem.

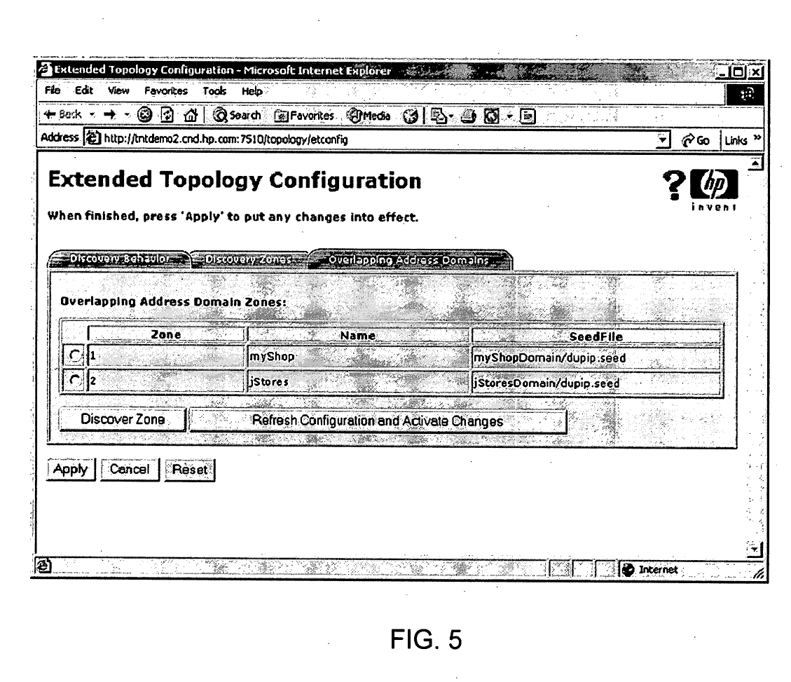

In one embodiment, the configuration and seed files (nor changes therein) do not affect the networking software currently running until they are loaded 412 into a configuration system and deployed 414 to the running configuration. The loading 412 and deployment 414 may be accomplished, in one specific implementation, using an Extended Topology Configuration GUI, such as the example web page depicted in FIG. 5. In that example, the files (and changes therein) are copied to the running configuration when the “Overlapping Address Domains” tab is selected and the “Refresh Configuration and Activate Changes” button therein is clicked.

FIG. 5 is a screen shot depicting a graphical user interface relating to extended topology configuration in accordance with an embodiment of the invention. Here, the GUI comprises web page. As shown, the GUI is configured to provide for activating the discovery of one or more domain zones (“discover zone” button). The GUI is further configured to provide for “refreshing the configuration and activating changes” so as to deploy the configuration.

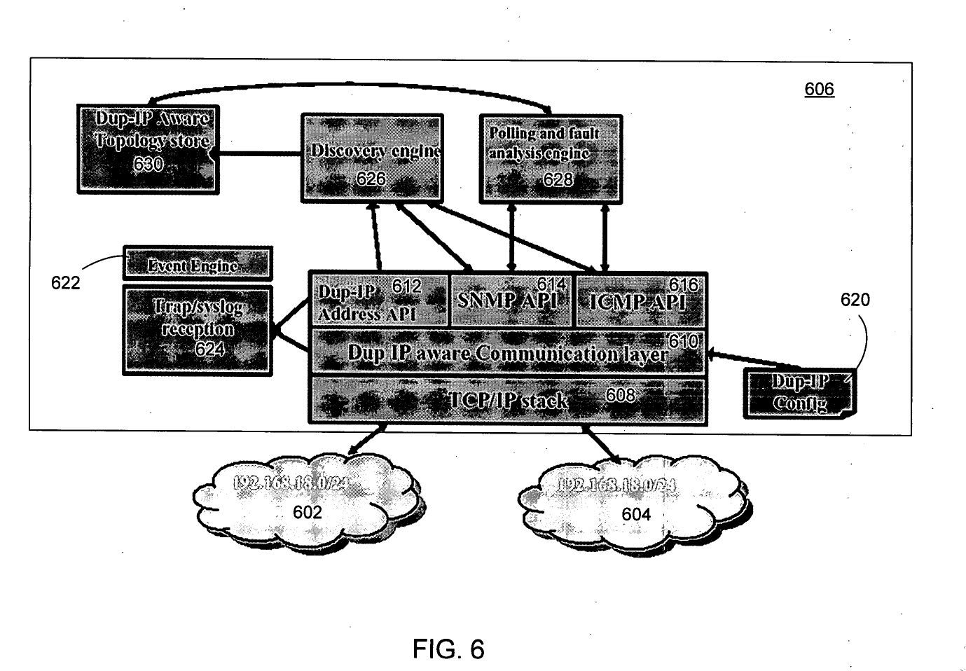

FIG. 6 is a schematic diagram of the architecture for a central system managing multiple overlapping address domains in accordance with an embodiment of the invention. The example network depicted includes two private networks 602 and 604 with overlapping address domains. Both of those networks are communicatively coupled to the central network management system 606.

The system 606 includes various components. A TCP/IP stack 608 is provided to communicate with the private networks (and with other networks). Above the TCP/IP stack 610 resides a duplicate-IP-aware (Dup IP aware) communications layer 610, and above that layer 610 resides an application programming interface (API) layer. The API layer may include various APIs, including a duplicative IP Address API 612, an SNMP API 614, and an ICMP API 616.

Other components include duplicate IP (Dup IP) configuration and seed files which are discussed above. These files are accessible by way of the Dup IP aware communication layer 610 of the stack. In addition, there is an event engine 622 which includes a module 624 for trap/syslog reception. This module 624 receives and transmits communications by way of the Dup-IP address API 612 and/or the Dup IP-aware communications layer 610. A discovery engine 626 communicates by way of the Dup-IP Address API 612, SNMP API 614, and ICMP API 616. A polling and fault analysis engine communicates by way of the SNMP API 614 and ICMP API 616. A Dup-IP Aware Topology store component 630 is configured to receive data and/or communicatively interact with the discovery engine 626 and the analysis engine 628.

Using the information in the configuration and seed files, the management system software in FIG. 6 is enabled to go from a management IP address to the OAD id/private address pair (and vice-versa). This advantageously allows for a centralized system to manage a plurality of networks with overlapping private address domains.

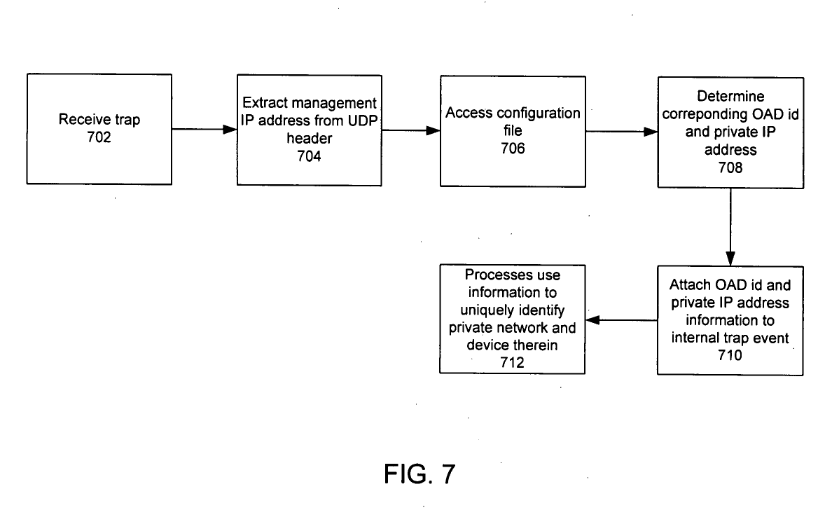

FIG. 7 is a flow chart depicting a method of processing a network management trap by a network management system 606 in accordance with an embodiment of the invention. For example, under SNMP, the trap command is used by managed devices to report events to the network management system. In other words, a network device sends a trap to the network management system when certain types of events occur.

When a trap is received 702 on a socket, a management address of the device from where the trap originated (i.e. the trap management address) is typically returned via the user datagram protocol (UDP) header. This management IP address is extracted 704 from the UDP header. The configuration file 620 is accessed 706 and the corresponding OAD id and private IP address are determined 708. Thereafter, the OAD id and private address information is attached 710 to the trap event generated internally at the network management system. Subsequent software processes at the network management system may then use 712 this information to uniquely identify the private network and the device therein from which the trap originated. Advantageously, this method enables the unique identification of the private network and device therein that a trap comes from, even if duplicate private IP addresses exist in the network.

An active route is a current route packets take through network devices to get from a source device to a destination device. Active route information is valuable because knowing the active route is useful to the determination of where problems could be that are limiting bandwidth or stopping traffic.

Routers update tables, such as an IP address table and an IP routing table, during the course of normal operation. These tables allow the router to adapt to its surroundings to know the preferable way to forward a packet to get the packet to its destination quickly. Algorithms to find an active route typically query these tables in order to predict the flow of packets (without having to send test packets). However, a problem arises when the destination device resides in a private network, protected by a static NAT device. The problem is that the static NAT device will not reveal details on how it forwards packets.

The present application discloses mechanisms to inform network management software of the details of a private network behind a static NAT device. In particular, the above-described gateway command in the configuration file 406 indicates the gateway static NAT device used to enter the private network. In a specific implementation, the configuration file may include the following gateway command: Gateway IP=“133.45.22.1”. This command indicates to the network management software that the device at IP address 133.45.22.1 is a static NAT device and is used as a gateway into the private network associated with the configuration file.

In accordance with an embodiment of the invention, an additional command is provided in the configuration file. In one implementation, the additional command is of the following form: NextHop IP=“133.45.23.1”. This next hop command indicates that the packets will flow from the gateway address (for example, 133.45.22.1) to the next hop address (for example, 133.45.23.1) as the packets enter the private network. The next hop address given is an external (management) address that can be communicated and used outside the private network. The device at the next hop address is located inside the private network, so that device also has a private address (in addition to the external address).

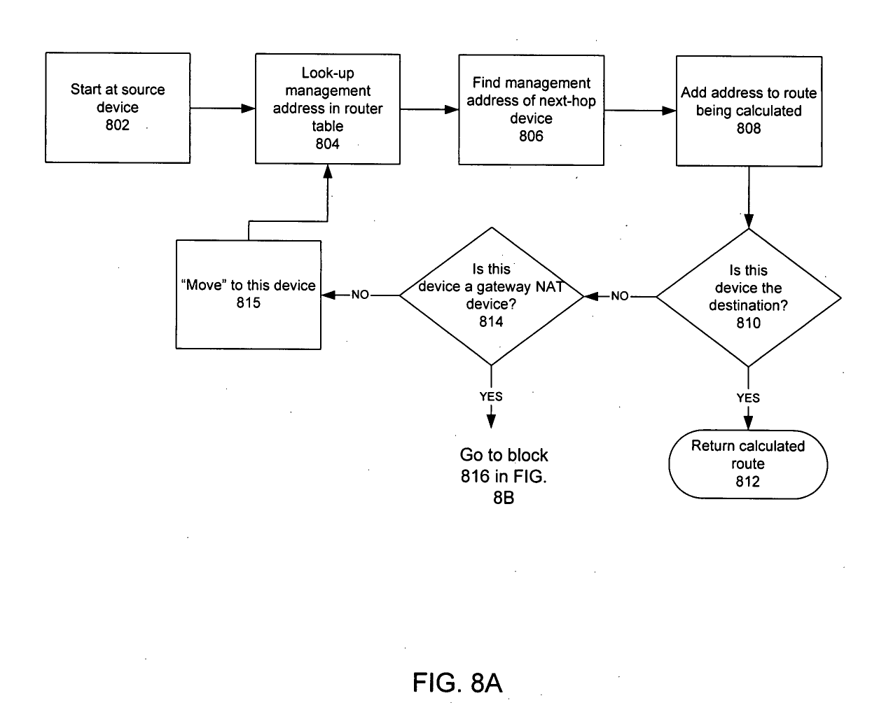

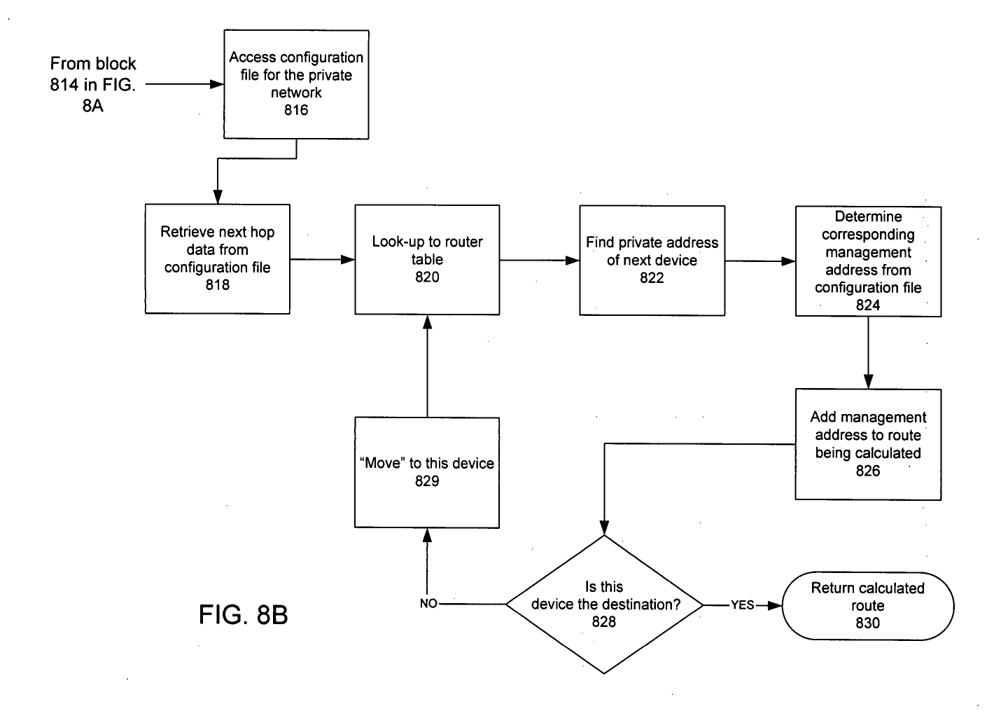

FIGS. 8A and 8B are flow diagrams depicting an algorithm for finding an active route taken by a packet crossing a static NAT device into a private network in accordance with an embodiment of the invention.

As shown in FIG. 8A, starting 802 at the source device of the route, a look-up 804 to the router tables at the source is used to find 806 the management (external or public) address of the next-hop device on the route to the destination. The management address is added 808 to the calculated route.

A determination is made 810 as to whether this device is the destination device. If this device is the destination, then the algorithm may return 812 the route being calculated.

Otherwise, a determination is made 814 as to whether this device is a gateway NAT device. If this device is not a gateway device, then the algorithm “moves” 815 to it. The algorithm then loops back and performs the look-up 804 to the router tables at this device, finds 806 the next-hop device along the route, and adds 808 that the management address for the next-hop device to the route being calculated. The algorithm continues in this way until the destination or a gateway is reached.

If a gateway NAT device is reached, then the algorithm continues as depicted in FIG. 8B. As shown in FIG. 8B, the configuration file (discussed above) for the private network is accessed 816. The next hop data is retrieved 818 from the configuration file, and using the next hop data a look-up 820 is performed to the router table for the private network. From the look-up, the private address for the next device is found 822. Using this private address, the corresponding management address is determined 824 from the configuration file. That management address (and perhaps the associated private address) is added 826 to the route being calculated.

A determination 828 is then made as to whether this device is the destination device. If this device is not the destination device, then the algorithm “moves” 829 to this device. The algorithm then loops back and again performs the look-up 820 to the router tables for the private network, finds 822 the private address for the next device, determines 824 the corresponding management address, and adds 826 that address to the route being calculated. The algorithm continues in this way until the destination is reached. When the destination is finally reached, then the calculated route is returned 830. Advantageously, the calculated route comprises a complete list of hops taken from the source through the static NAT to the destination.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

1. A system for managing a network including multiple overlapping private address domains, the system comprising:
a computer system including software for a network management system; and
a plurality of network address translation (NAT) devices, each NAT device in the plurality being communicatively coupled to said computer system and communicatively coupled to one of the overlapping private address domains,
wherein a route distinguisher is associated with each overlapping private address domain to facilitate management thereof.

2. The system of claim 1, wherein the route distinguisher comprises an identification number.

3. The system of claim 2, wherein the route distinguisher further comprises a name string.

4. The system of claim 1, further comprising:
one or more configuration files accessible by the network management system and configured to store the route distinguisher.

5. The system of claim 1, further comprising:
a transmission control protocol/internet protocol (TCP/IP) stack in said computer system; and
a communication layer above the TCP/IP stack,
wherein said communication layer is configured to be aware of the multiple overlapping private address domains.

6. The system of claim 5, further comprising:
an application programming interface (API) layer above said communication layer,
wherein the API layer includes a duplicated-IP-address API, an SNMP API, and an ICMP API.

7. The system of claim 6, further comprising:
a module for trap/syslog reception communicatively coupled to said communication layer and to the duplicated-IP-address API.

8. The system of claim 7, further comprising:
a discovery engine coupled to said API layer.

9. The system of claim 8, further comprising:
data storage for storing a duplicated-IP-address aware network topology,
wherein said data storage is configured to be accessed by the discovery engine and by a fault analysis engine.

10. A method of configuring a network including multiple overlapping private address domains (OADs), the method comprising creating a configuration file for each OAD, wherein the configuration file includes an identifier for the OAD, a gateway address to the OAD, and mappings between private addresses in the OAD and corresponding management addresses.

11. The method of claim 10, further comprising creating a seed file for each OAD, wherein the seed file defines a discovery zone for the OAD.

12. The method of claim 11, further comprising verifying a correct syntax of the configuration and seed files.

13. The method of claim 12, further comprising:
loading data from the configuration and seed files into a network management system using a graphical user interface (GUI) to said system.

14. The method of claim 13, wherein the GUI includes a screen configured to display an identifying number, an identifying name, and a seed file name for each OAD, and wherein the screen is further configured to allow a user to initiate discovery for each OAD and to initiate deployment of changes to the running configuration.

15. A method of processing a trap from a network with multiple overlapping private address domains, the method comprising:
receiving a trap packet originating from a managed network device;
extracting a management internet protocol (IP) address from a header of the trap packet;
determining a domain identifier and a private IP address corresponding to the management IP address; and
using the domain identifier and private IP address to uniquely identify the managed network device.

16. The method of claim 15, wherein the trap packet comprises a simple network management protocol (SNMP) trap.

17. The method of claim 15, wherein the header comprises a user datagram protocol (UDP) header.

18. The method of claim 15, wherein the domain identifier and private IP address are retrieved from a configuration file accessible by the network management system.

19. The method of claim 15, wherein the domain identifier comprises an identifier for an overlapping private address domain.

20. The method of claim 15, further comprising:
attaching the domain identifier and the private IP address to an internal trap event for use by other software processes.

21. A method of finding an active route across a static network address translation (NAT) device, the method comprising:
finding a gateway to a private network, wherein the gateway comprises the static NAT device;
looking-up a private address of a next device in the private network;
determining a corresponding management address;
adding the management address to a route being calculated; and
repeating the looking-up, determining, and adding steps until the next device comprises a destination device.

22. The method of claim 21, further comprising, prior to finding the gateway:
looking-up a management address of a next-hop device;
adding the management address to the route being calculated; and
repeating the preceding two steps until the next-hop device comprises the gateway or the destination device.

23. The method of claim 21, wherein the corresponding management address is determined from a configuration file for an overlapping private address domain including mappings between private and management addresses.

24. An apparatus for configuring a network including multiple overlapping private address domains (OADs), the apparatus comprising means for creating a configuration file for each OAD, wherein the configuration file includes an identifier for the OAD, a gateway address to the OAD, and mappings between private addresses in the OAD and corresponding management addresses.

25. An apparatus for processing a trap from a network with multiple overlapping private address domains, the apparatus comprising:
means for receiving a trap packet originating from a managed network device;
means for extracting a management internet protocol (IP) address from a header of the trap packet;
means for determining a domain identifier and a private IP address corresponding to the management IP address; and
means for using the domain identifier and private IP address to uniquely identify the managed network device.

26. An apparatus for finding an active route across a static network address translation (NAT) device, the apparatus comprising:
means for finding a gateway to a private network, wherein the gateway comprises the static NAT device;
means for looking-up a private address of a next device in the private network;
means for determining a corresponding management address;
means for adding the management address to a route being calculated; and
means for repeating the looking-up, determining, and adding steps until the next device comprises a destination device.
